(19) United States
(12) Patent Application Publication
(10) Pub. No.: US 2022/0083896 A9
(43) Pub. Date: Mar. 17, 2022

(54) SYSTEMS AND METHODS FOR IMPROVED MODELLING OF PARTITIONED DATASETS

(71) Applicant: Userzoom Technologies, Inc., Dover, DE (US)

(72) Inventors: Xavier Mestres, Barcelona (ES); Robert Derward Rogers, Oakland, CA (US)

(21) Appl. No.: 16/846,172

(22) Filed: Apr. 10, 2020

Related U.S. Application Data
(60) Provisional application No. 62/833,641, filed on Apr. 12, 2019.
(60) Provisional application No. 62/835,491, filed on Apr. 17, 2019.

(51) Int. Cl. G06N 20/00; G06F 16/903

(52) U.S. Cl. CPC G06N 20/00; G06F 16/90335

(57) ABSTRACT

Systems and methods for improving an algorithm using physically or logically partitioned datasets, in compliance with use restrictions, is provided. The datasets belong to various customers in local data modules. A policy database is queried for use restrictions (contractual or legal) on the partitioned datasets. The datasets are then cataloged, and a set of functionalities are generated and then deployed. This deployment may include running the functionality on a central system on partitions of the datasets adhering to the restrictions, or packaging the functionality into discrete bins for each of the datasets, and delivering the bins to local computational devices at each local data module. The output of the functionalities are then aggregated, typically with a weighted function, and then used to train a unified algorithm.

### CROSS REFERENCE TO RELATED APPLICATIONS

This application claims the benefit of U.S. provisional applications, of the same title, U.S. application Ser. No. 62/833,641, filed in the USPTO on Apr. 12, 2019 and U.S. application Ser. No. 62/835,491, filed in the USPTO on Apr. 17, 2019, by inventors Mestres et al., which are incorporated herein by reference.

This application is also a continuation-in-part application and claims the benefit of U.S. application entitled “System and method for unmoderated remote user testing and card sorting,” U.S. application Ser. No. 13/112,792, Attorney Docket No. UZM-1001, filed in the USPTO on May 20, 2011, by inventor Mestres et al., which is incorporated herein by reference.

### BACKGROUND

The present invention relates to systems and methods for machine learning model improvements generally, and specifically the improvement of machine learning models as they apply to the behaviors of consumers. In some embodiments, the generation of studies that allow for insight generation for the usability of a website is performed, which generates significant volumes of user/consumer related data. Generally, this type of testing is referred to as “User Experience” or merely “UX” testing. Due to legal and contractual obligations, however, the resulting data from these studies cannot be readily comingled.

A user experience company performing these UX studies for a range of clients is faced with a huge opportunity to expand upon its past success by combining data from its large customer base and operational history with recent advances in algorithms and Artificial Intelligence (AI). For the purposes of this disclosure, since all AI is based on algorithms, we will refer to all algorithmic methods, including but not limited to forecasting, predictive analytics, machine learning, inference and AI as “algorithms.”

The challenge for such a user experience company is that the vast data resources that it has at its disposal as a result of extensive customer research, development and operational activity cannot be combined into a single large data set because of contractual restrictions, as well as legal constraints/privacy laws. Specifically, in many cases, a user experience company has the ability to compute on individual customer data sets, and may have the data actually stored within a user experience company controlled computing environment, but may not combine data sets from different customers logically or physically.

It is well established in data science that algorithms are most effective (accuracy, robustness, generalizability, etc.) when they are trained on diverse data sets. It is also generally understood that, in general, the more data that is available for algorithmic training, the more subtle and useful the resulting algorithm will be.

It is therefore apparent that an urgent need exists for advancements in the handling of data sets generated under conditions where commingling of the data is prohibited. Such systems and methods allow for improvements in algorithm training, which may provide more accurate, robust and effective machine driven decision processes.

### SUMMARY

To achieve the foregoing and in accordance with the present invention, systems and methods for improving an algorithm using physically or logically partitioned datasets, in compliance with use restrictions, is provided. The datasets belong to various customers in local data modules.

In some embodiments, the systems and methods first query a policy database for use restrictions on the partitioned datasets. These restrictions are contractually and legally mandated, and can include, for example, non-disclosure provisions or laws such as GDPR or HIPPA. The datasets are then cataloged, and a set of functionalities are generated.

The functionality applications might include computation on the datasets to generate new insights for customers, annotation of the datasets to allow new algorithm development or refinement of existing algorithms, training of algorithms on the datasets, and interactive operation of software workflows to allow collaboration between a user experience company and the customer or local operator.

Next these functionalities may be deployed for operation. This deployment may include running the functionality on a central system on partitions of the datasets adhering to the restrictions, or packaging the functionality into discrete bins for each of the datasets, and delivering the bins to local computational devices at each local data module.

The output of the functionalities are then aggregated, typically with a weighted function. This weighting may be based upon confidence value for the output, sample size of the dataset, diversity of the dataset, longevity of the dataset, and historic predictive accuracy of the dataset. The aggregated outputs are then used to train a unified algorithm.

Note that the various features of the present invention described above may be practiced alone or in combination. These and other features of the present invention will be described in more detail below in the detailed description of the invention and in conjunction with the following figures.

### BRIEF DESCRIPTION OF THE DRAWINGS

In order that the present invention may be more clearly ascertained, some embodiments will now be described, by way of example, with reference to the accompanying drawings, in which:

FIG. 1 is an example logical diagram of a system for user experience studies coupled with a data learning system, in accordance with some embodiment;

FIG. 2 is an example logical diagram of the usability testing system, in accordance with some embodiment;

FIG. 3 is an example logical diagram of the virtual moderator server of the usability system, in accordance with some embodiment;

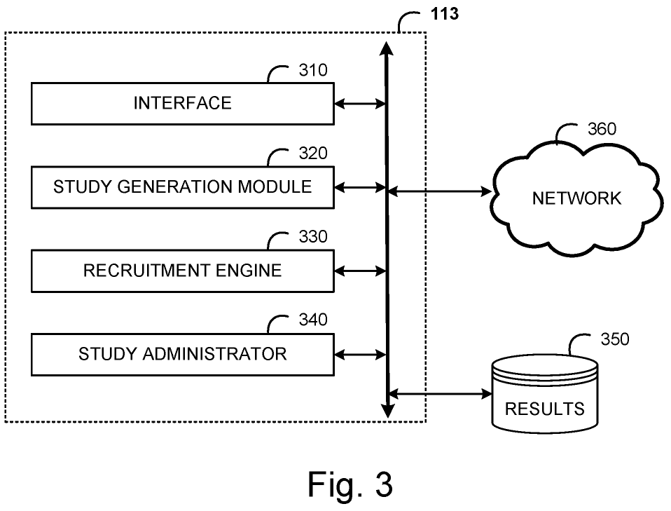

FIG. 4 is an example logical diagram of the integration module of the data learning system, in accordance with some embodiment;

FIG. 5 is an example logical diagram of a consumer data module of the data learning system, in accordance with some embodiment;

FIG. 6 is an example process of user experience testing, in accordance with some embodiment;

FIG. 7 is a flow diagram for the example process of study generation, in accordance with some embodiment;

FIG. 8 is a flow diagram for the example process of study administration, in accordance with some embodiment;

FIG. 9 is a flow diagram for the example process of insight generation, in accordance with some embodiment;

FIG. 10 is a flow diagram for the example process of model improvement from separate data sources, in accordance with some embodiments;

FIG. 11 is a flow diagram for the example process of functionality development for the customer data modules, in accordance with some embodiments;

FIG. 12 is a flow diagram for the example process of functionality deployment, in accordance with some embodiments;

FIG. 13 is a flow diagram for the example process of data aggregation for model improvement, in accordance with some embodiments; and

FIGS. 14A and 14B are example illustrations of a computer system capable of embodying the current invention.

### DETAILED DESCRIPTION

The present invention will now be described in detail with reference to several embodiments thereof as illustrated in the accompanying drawings. In the following description, numerous specific details are set forth in order to provide a thorough understanding of embodiments of the present invention. It will be apparent, however, to one skilled in the art, that embodiments may be practiced without some or all of these specific details. In other instances, well known process steps and/or structures have not been described in detail in order to not unnecessarily obscure the present invention. The features and advantages of embodiments may be better understood with reference to the drawings and discussions that follow.

Aspects, features and advantages of exemplary embodiments of the present invention will become better understood with regard to the following description in connection with the accompanying drawing(s). It should be apparent to those skilled in the art that the described embodiments of the present invention provided herein are illustrative only and not limiting, having been presented by way of example only. All features disclosed in this description may be replaced by alternative features serving the same or similar purpose, unless expressly stated otherwise. Therefore, numerous other embodiments of the modifications thereof are contemplated as falling within the scope of the present invention as defined herein and equivalents thereto. Hence, use of absolute and/or sequential terms, such as, for example, “will,” “will not,” “shall,” “shall not,” “must,” “must not,” “first,” “initially,” “next,” “subsequently,” “before,” “after,” “lastly,” and “finally,” are not meant to limit the scope of the present invention as the embodiments disclosed herein are merely exemplary.

The present invention relates to enhancements to improvements in the training and building of algorithms. Particular attention will be placed upon the leveraging of datasets generated via user experience testing and subsequent insight generation. These datasets include rich consumer behavior data that may be leveraged to generate user experience insights, but also may be employed more broadly for the determination of consumer trends and preferences. Machine learning models utilizing such data sources may be useful for a wide variety of endeavors, including promotional design, marketing, and product offering decision making.

In the following it is understood that the term usability refers to a metric scoring value for judging the ease of use of a target web site. A client refers to a sponsor who initiates and/or finances the usability study. The client may be, for example, a marketing manager who seeks to test the usability of a commercial web site for marketing (selling or advertising) certain products or services. Participants may be a selected group of people who participate in the usability study and may be screened based on a predetermined set of questions. Remote usability testing or remote usability study refers to testing or study in accordance with which participants (referred to use their computers, mobile devices or otherwise) access a target web site in order to provide feedback about the web site's ease of use, connection speed, and the level of satisfaction the participant experiences in using the web site. Unmoderated usability testing refers to communication with test participants without a moderator, e.g., a software, hardware, or a combined software/hardware system can automatically gather the participants' feedback and records their responses. The system can test a target web site by asking participants to view the web site, perform test tasks, and answer questions associated with the tasks.

While such systems and methods may be utilized with a user experience environment, embodiments described herein are equally applicable to any collection of datasets which are contractually or legally required to be separated, but where model training could be improved by having access to the larger set of data. For example, healthcare providers may employ machine learning to calculate pathology risks, improved healthcare delivery and billing reimbursement enhancements. In this field of endeavor, the data sets utilized include patient data, which is strictly controlled by privacy laws. In the United States, for example, HIPPA is an expansive set of laws and regulation which delineate the usage of patient data. The present systems and methods could be employed within a healthcare setting to enhance models by leveraging the larger datasets available while maintaining the legal privacy/data segregation requirements.

As such, while the present disclosure will focus upon user experience testing, and how the resulting customer data can be leveraged to improve algorithms, it should be understood that this is done for exemplary purposes. The scope of the systems and methods are in no way limited to user experience testing environments, and may be employed to any situations where there are datasets available that need to be maintained separated (either logically or physically) for any reason.

Some descriptions of the present systems and methods will also focus nearly exclusively upon the user experience within a retailer's website. This is intentional in order to provide a clear use case and brevity to the disclosure, however it should be noted that the present systems and methods apply equally well to any situation where a user experience in an online platform is being studied. As such, the focus herein on a retail setting is in no way intended to artificially limit the scope of this disclosure.

The following description of some embodiments will be provided in relation to numerous subsections. The use of subsections, with headings, is intended to provide greater clarity and structure to the present invention. In no way are the subsections intended to limit or constrain the disclosure contained therein. Thus, disclosures in any one section are intended to apply to all other sections, as is applicable.

The following systems and methods are for improvements algorithm generation or training by leveraging multiple datasets that are maintained separately due to contractual obligations, or due to legal restrictions. As noted previously, in usability testing, a series of data sets belonging to different customers is generated. These customers generally include a retailer chain or other merchant corporation. Data derived for these customers about users of their systems is regarded as valuable trade secret information. As such, this data is generally protected by non-disclosure provisions in contracts. The user experience testing company contractually agrees with these customer companies not to co-mingle or share the data with competitors. This generates a contractual silo between each collected dataset. Further, the data itself may include personally identifying information, and other sensitive information (e.g., financial or medical data) which may further be subject of privacy regulations and laws requiring this data to be maintained separately.

The present systems and methods overcome these limitations on the data usage by employing functionalities that adhere to these separation policies in order to abstract the data in a manner that enables aggregation of the abstractions to train or otherwise improve the algorithms.

A. Data Learning Ecosystem

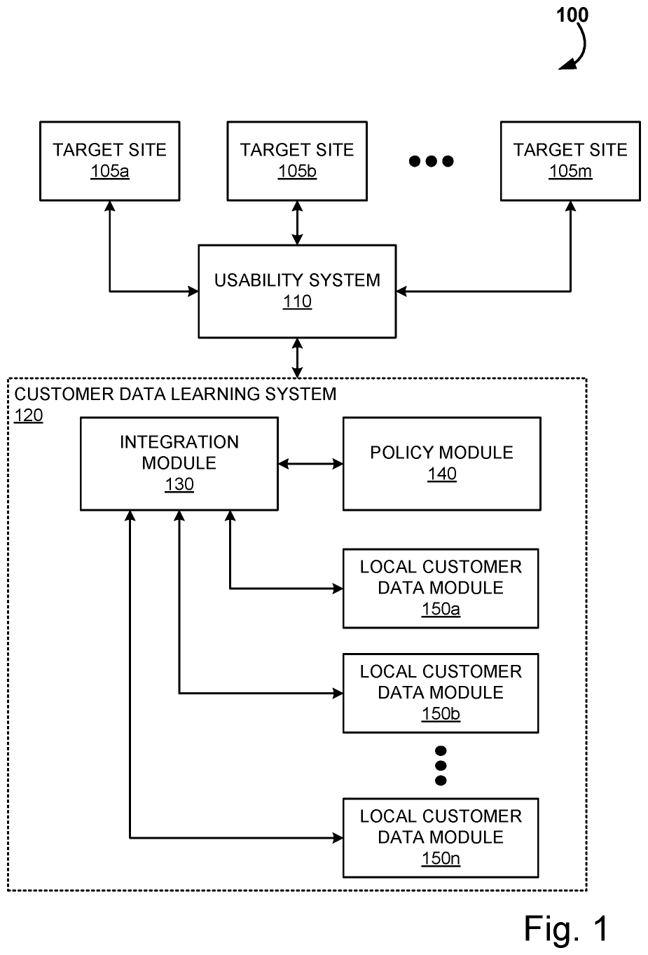

To facilitate the discussion, FIG. 1 is a simplified block diagram 100 of a user testing platform 110 coupled to a data learning system 120 according to an embodiment. The usability system 100 is adapted to test target web sites 105a-m. The usability testing system 110 is in communications with data processing units, which may be a personal computer equipped with a monitor, a handheld device such as a tablet PC, an electronic notebook, a wearable device such as a cell phone, or a smart phone.

A data processing unit includes a browser that enables a user (e.g., usability test participant) to access a target web site 105a-m. The data processing unit includes, in part, an input device such as a keyboard, a mouse and/or a touch screen, and a participant browser. In some embodiments, the data processing unit may insert a virtual tracking code to target web site 105a-m in real-time while the target web site is being downloaded to the data processing unit. The virtual tracking code may be a proprietary JavaScript code, whereby the run-time data processing unit interprets the code for execution. The tracking code collects participants' activities on the downloaded web page such as the number of clicks, key strokes, keywords, scrolls, time on tasks, and the like over a period of time. Data processing unit simulates the operations performed by the tracking code and is in communication with usability testing system 110 via a communication link, such as a local area network, a metropolitan area network, and/or a wide area network. Such a communication link may be established through a physical wire or wirelessly. For example, the communication link may be established using an Internet protocol such as the TCP/IP protocol.

Activities of the participants associated with target web site 105a-m are collected and sent to usability testing system 110 via the communication link. In some embodiment, data processing unit may instruct a participant to perform predefined tasks on the downloaded web site during a usability test session, in which the participant evaluates the web site based on a series of usability tests. The virtual tracking code (e.g., a proprietary JavaScript) may record the participant's responses (such as the number of mouse clicks) and the time spent in performing the predefined tasks. The usability testing may also include gathering performance data of the target web site such as the ease of use, the connection speed, the satisfaction of the user experience. Because the web page is not modified on the original web site, but on the downloaded version in the participant data processing unit, the usability can be tested on any web sites including competitions' web sites.

Data collected by data processing unit may be sent to the usability testing system 110 via communication link. This data can then be further provided to the customer data learning system 120 in a physically or logically separate data store, or within a local customer data module 150a-n. In an embodiment, usability testing system 110 is further accessible by a client via a client browser, and by a user experience researcher browser. A client and/or user experience researcher may design one or more sets of questionnaires for screening participants and for testing the usability of a web site.

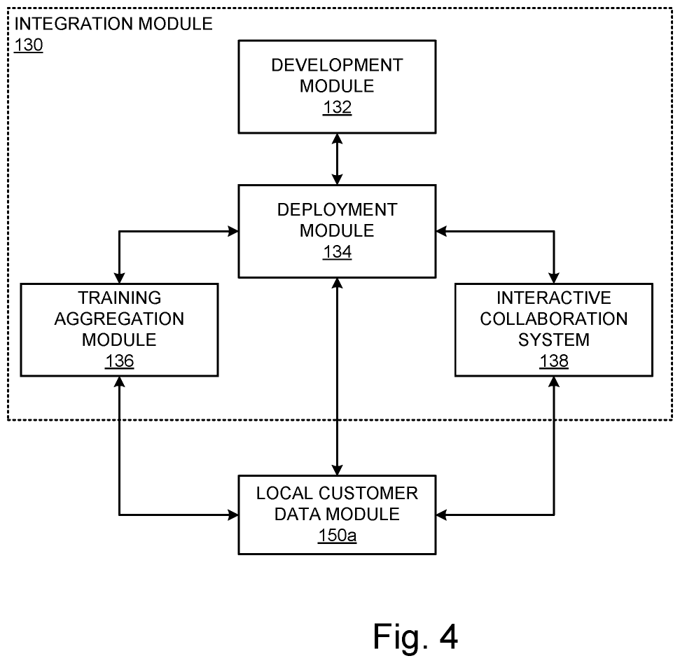

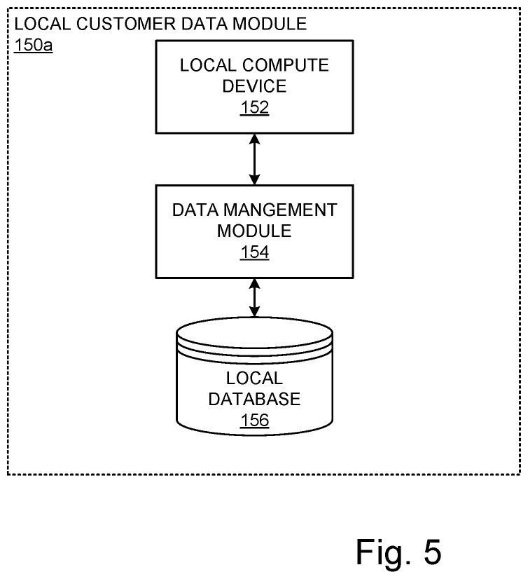

The customer data learning system 120 includes three primary subcomponents, including an integration module 130 a policy module 140 and the plurality of local customer data modules 150a-n. The specifics of these modules will be discussed in greater detail in relation to FIGS. 4 and 5.

The customer data learning system 120 is an end-to-end data management, algorithm development, computing and reporting system that allows its operator to develop algorithms that can be trained and run on separate customer data sets, but which can use recently developed training algorithms to aggregate these results into single algorithms that have effectively learned from all the data. The result is powerful algorithms that reflect the wisdom contained in all of the separate customer data sets, but which were developed without the need to combine the data or otherwise violate the privacy and security agreements between the user experience company and its customers (or any entity that is restricted in how it can leverage data sets).

The customer data learning system 120 in some embodiments maintains all local customer data within a computing and storage infrastructure maintained by the user experience company. In some embodiments, the software components created and deployed within the system will actually be run on computing infrastructure maintained separately by a customer or third party, in which case packaged bins of software will be deployed and managed in separate logical structures. In some embodiments, the user experience company with collaborate directly with customers or local operators to carry out synchronous activities which could range from carrying out new the user experience studies, to annotating existing data with new labels, to cleaning or transforming data, or many other tasks which require coordination between the local data and the user experience company.

The integration module 130 controls the creation and management of separate data sets in the customer data learning system 120 environment. Specifically, this module catalogs the data that is present in each of the separate local customer data modules 150a-n. The policy module 140 maintains records of all contractual sharing and use requirements (including and legal requirements of data usage or sharing). The integration module 130 combines the policy data, and the catalog information of the customer data modules 150a-n, along with any user-generated annotations or other results that are suitable for training of algorithms or generation of inferences.

Outputs from the integration module 130 that are provided to the local customer data modules 150a-n also include software that can operate on the local data for a variety of purposes, including but not limited to annotation of data for algorithm training purposes, performance of new studies on customer data, and training of algorithms on local data.

Inputs from the local customer data modules 150a-n can include, for example, results of computations on data, newly trained algorithms, parameters of newly trained algorithms, interactive data, text, and video from interactions with customers and local operators, and metadata about data in the local customer data modules 150a-n. The local customer data modules 150a-n also aggregates parameters and models from algorithm training on multiple separate data sets to generate new algorithms that effectively learn simultaneously from data in all of the local customer data modules 150a-n without the need to combine data logically or physically.

The local customer data modules 150a-n contains local customer data and any annotations or other data enhancements that should logically reside with local data. This module receives data and software from the integration module 130. The local customer data modules 150a-n run software received from the integration module 130 on local data to generate annotations, to create new insights for customers and to train algorithms on local data, among many other potential applications. The local customer data modules 150a-n transmit a variety of results from these locally performed computations to the integration module 130, including interactions with customers and local operators, and raw data when contractually appropriate (per the policy module 140). In some embodiments, the local customer data modules 150a-n run within the computing infrastructure of the user experience corporation, and in other embodiments they run within external systems (either third party hosted, or customer internal IT systems).

B. Usability System and Methods

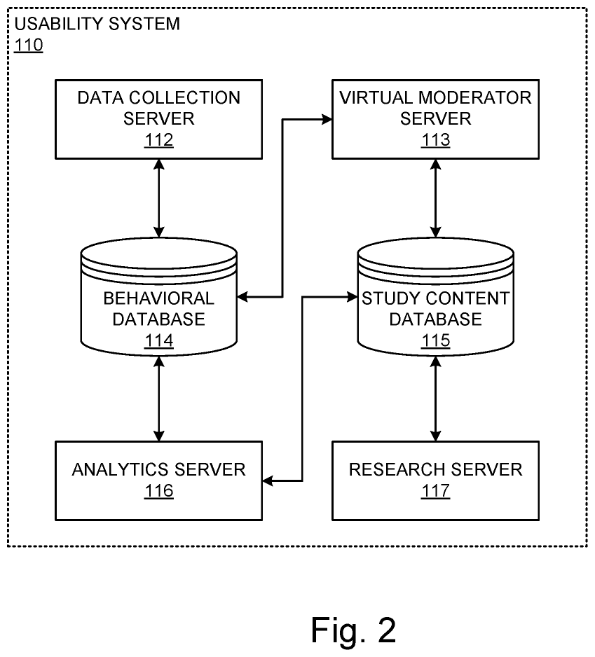

Now that the overarching environment has been discussed, particular attention will be placed upon the usability system and data learning system, respectively. The usability testing system 110 is described in detail in relation to FIG. 2. Usability testing system 110 includes a virtual moderator software module running on a virtual moderator server 113 that conducts interactive usability testing with a usability test participant via the data processing unit and a research module running on a research server 117. The user experience researcher may create tasks relevant to the usability study of a target web site and provide the created tasks to the research server 117 via a communication link. One of the tasks may be a set of questions designed to classify participants into different categories or to prescreen participants. Another task may be, for example, a set of questions to rate the usability of a target web site based on certain metrics such as ease of navigating the web site, connection speed, layout of the web page, ease of finding the products (e.g., the organization of product indexes). Yet another tasks may be a survey asking participants to press a “yes” or “no” button or write short comments about participants' experiences or familiarity with certain products and their satisfaction with the products. All these tasks can be stored in a study content database 115, which can be retrieved by the virtual moderator module running on virtual moderator server 113 to forward to participants. Research module running on research server 117 can also be accessed by a client (e.g., a sponsor of the usability test) who, like user experience researchers, can design her own questionnaires since the client has a personal interest to the target web site under study. Client can work together with user experience researchers to create tasks for usability testing. In an embodiment, client can modify tasks or lists of questions stored in the study content database 115. In another embodiment, client can add or delete tasks or questionnaires in the study content database 115. In yet another embodiment, client may be the same entity as the user experience researcher.

In some embodiment, one of the tasks may be open or closed card sorting studies for optimizing the architecture and layout of the target web site. Card sorting is a technique that shows how online users organize content in their own mind. In an open card sort, participants create their own names for the categories. In a closed card sort, participants are provided with a predetermined set of category names. Client and/or user experience researcher can create proprietary online card sorting tool that executes card sorting exercises over large groups of participants in a rapid and cost-effective manner. In an embodiment, the card sorting exercises may include up to 100 items to sort and up to 12 categories to group. One of the tasks may include categorization criteria such as asking participants questions “why do you group these items like this?.” Research module on research server 117 may combine card sorting exercises and online questionnaire tools for detailed taxonomy analysis. In an embodiment, the card sorting studies are compatible with SPSS applications.

In an embodiment, the card sorting studies can be assigned randomly to participant. User experience (UX) researcher and/or client may decide how many of those card sorting studies each participant is required to complete. For example, user experience researcher may create a card sorting study within 12 tasks, group them in 4 groups of 3 tasks and manage that each participant just has to complete one task of each group.

After presenting the thus created tasks to participants through virtual moderator module (running on virtual moderator serer 113), the actions/responses of participants will be collected in a data collecting module running on a data collecting server 112 via a communication link. In an embodiment, this communication link may be a distributed computer network and share the same physical connection as other communication links. This is, for example, the case where data collecting module 112 locates physically close to virtual moderator module 113, or if they share the usability testing system's processing hardware. In the following description, software modules running on associated hardware platforms will have the same reference numerals as their associated hardware platform. For example, virtual moderator module will be assigned the same reference numeral as the virtual moderator server 113, and likewise data collecting module will have the same reference numeral as the data collecting server 112.

Data collecting module 112 may include a sample quality control module that screens and validates the received responses, and eliminates participants who provide incorrect responses, or do not belong to a predetermined profile, or do not qualify for the study. Data collecting module 112 may include a “binning” module that is configured to classify the validated responses and stores them into corresponding categories in a behavioral database 114.

Merely as an example, responses may include gathered web site interaction events such as clicks, keywords, URLs, scrolls, time on task, navigation to other web pages, and the like. In one embodiment, virtual moderator server 113 has access to behavioral database 114 and uses the content of the behavioral database to interactively interface with participants. Based on data stored in the behavioral database, virtual moderator server 113 may direct participants to other pages of the target web site and further collect their interaction inputs in order to improve the quantity and quality of the collected data and also encourage participants' engagement. In one embodiment, virtual moderator server may eliminate one or more participants based on data collected in the behavioral database. This is the case if the one or more participants provide inputs that fail to meet a predetermined profile.

Usability testing system 110 further includes an analytics module 116 that is configured to provide analytics and reporting to queries coming from client or user experience (UX) researcher. In an embodiment, analytics module 116 is running on a dedicated analytics server that offloads data processing tasks from traditional servers. Analytics server 116 is purpose-built for analytics and reporting and can run queries from client and/or user experience researcher much faster (e.g., 100 times faster) than conventional server system, regardless of the number of clients making queries or the complexity of queries. The purpose-built analytics server 116 is designed for rapid query processing and ad hoc analytics and can deliver higher performance at lower cost, and, thus provides a competitive advantage in the field of usability testing and reporting and allows a company such as UserZoom (or Xperience Consulting, SL) to get a jump start on its competitors.

In an embodiment, research module 117, virtual moderator module 113, data collecting module 112, and analytics server 116 are operated in respective dedicated servers to provide higher performance. The client (sponsor/customer) and/or the user experience research may receive usability test reports by accessing analytics server 116. Analytics server 116 may communicate with behavioral database via a two-way communication link.

In an embodiment, study content database 115 may include a hard disk storage or a disk array that is accessed via iSCSI or Fiber Channel over a storage area network. In an embodiment, the study content is provided to analytics server 116 so that analytics server 116 can retrieve the study content such as task descriptions, question texts, related answer texts, products by category, and the like, and generate together with the content of the behavioral database 114 comprehensive reports to client and/or user experience researcher.

The behavioral database 114 can be a network attached storage server or a storage area network disk array that includes a two-way communication with the virtual moderator server 113. Behavioral database 114 is operative to support virtual moderator server 113 during the usability testing session. For example, some questions or tasks are interactively presented to the participants based on data collected. It would be advantageous to the user experience researcher to set up specific questions that enhance the usability testing if participants behave a certain way. If a participant decides to go to a certain web page during the study, the virtual moderator server 113 will pop up corresponding questions related to that page; and answers related to that page will be received and screened by data collecting server 112 and categorized in the behavioral database 114. In some embodiments, the virtual moderator server 113 operates together with data stored in the behavioral database to proceed the next steps. Virtual moderator server, for example, may need to know whether a participant has successfully completed a task, or based on the data gathered in behavioral database 114, present another tasks to the participant.

The client and user experience researcher may provide one or more sets of questions associated with a target web site to research server 117. The research server 117 stores the provided sets of questions in a study content database 115 that may include a mass storage device, a hard disk storage or a disk array being in communication with research server 117 through a two-way interconnection link. The study content database may interface with virtual moderator server 113 and provides one or more sets of questions to participants via virtual moderator server 113.

The virtual moderator server 113 may include a number of subcomponents, each logically coupled with one another, as seen in relation to FIG. 5. An interface 310 is illustrated for accessing the results 370 which may be stored internally or in an external data repository. In some embodiments, these results may be housed in the individual customer data modules 150a-n. The interface is also configured to couple with the network 360, which most typically is the Internet, which enables the system to couple to the target sites 105a-m and the data learning system 120.

The other significant components of the user virtual moderator server 113 includes a study generation module 320, a recruitment engine 330, a study administrator 340 and a research module 350. The study generation module 320 may include an offline template module which provides a system user with templates in a variety of languages (pre-translated templates) for study generation, screener questions and the like, based upon study type. Users are able to save any screener question, study task, etc. for usage again at a later time, or in another study.

In some embodiments a user may be able to concurrently design an unlimited number of studies, but is limited in the deployment of the studies due to the resource expenditure of participants and computational expense of the study insight generation. As such, a subscription administrator manages the login credentialing, study access and deployment of the created studies for the user. In some embodiments, the user is able to have subscriptions that scale in pricing based upon the types of participants involved in a stud, and the number of studies concurrently deployable by the user/client.

A translation engine may include machine translation services for study templates and even allow on the fly question translations. A screener module is configured to allow for the generation of screener questions to weed through the participants to only those that are suited for the given study. This may include basic Boolean expressions with logical conditions to select a particular demographic for the study. However, the screener module may also allow for advanced screener capabilities where screener groups and quotas are defined, allowing for advanced logical conditions to segment participants.

The recruitment engine 330 is responsible for the recruiting and management of participants for the studies. Generally, participants are one of three different classes: 1) core panel participants, 2) general panel participants, and 3) client provided participants. The core panel participants are compensated at a greater rate, but must first be vetted for their ability and willingness to provide comprehensive user experience reviews. Significant demographic and personal information can be collected for these core panel participants, which can enable powerful downstream analytics. The core panel vetting engine collects public information automatically for the participants as well as eliciting information from the participant to determine if the individual is a reliable panelists. Traits like honesty and responsiveness may be ascertained by comparing the information derived from public sources to the participant supplied information. Additionally, the participant may provide a video sample of a study. This sample is reviewed for clarity and communication proficiency as part of the vetting process. If a participant is successfully vetted they are then added to a database of available core panelists. Core panelists have an expectation of reduced privacy, and may pre-commit to certain volumes and/or activities.

Beyond the core panel is a significantly larger pool of participants in a general panel participant pool. This pool of participants may have activities that they are unwilling to engage in (e.g., audio and video recording for example), and are required to provide less demographic and personal information than core panelists. In turn, the general panel participants are generally provided a lower compensation for their time than the core panelists. Additionally, the general panel participants may be a shared pooling of participants across many user experience and survey platforms. This enables a demographically rich and large pool of individuals to source from. A large panel network manages this general panel participant pool.

Lastly, the user or client may already have a set of participants they wish to use in their testing. For example, if the user experience for an employee benefits portal is being tested, the client will wish to test the study on their own employees rather than the general public.

A reimbursement engine is involved with compensating participants for their time (often on a per study basis). Different studies may be ‘worth’ differing amounts based upon the requirements (e.g., video recording, surveys, tasks, etc.) or the expected length to completion. Additionally, the compensation between general panelists and core panelists may differ even for the same study. Generally, client supplied participants are not compensated by the reimbursement engine as the compensation (if any) is directly negotiated between the client and the participants.

Unlike many other user experience testing programs, the presently disclosed study administrator 340 includes the ability to record particular activities by the user. A recording enabler allows for the collection of click-flow information, audio collection and even video recording. In the event of audio and/or video recording the recording only occurs during the study in order to preserve participant privacy, and to focus attention on only time periods that will provide insights into the user experience. Thus, while the participant is engaged in screening questions, or other activities, recording may be disabled to prevent needless data accumulation. Recording only occurs after user acceptance (to prevent running afoul of privacy laws and regulations), and during recording the user may be presented with a clear indication that the session is being recorded. For example the user may be provided a thumbnail image of the video capture, in some embodiments. This provides notice to the user of the video recording, and also indicates video quality and field of view information, thereby allowing them to readjust the camera if needed or take other necessary actions (avoiding harsh backlight, increasing ambient lighting, etc.).

The screening engine administers the generated screener questions for the study. Screener questions, as previously disclosed, includes questions to the potential participants that may qualify or disqualify them from a particular study. For example, in a given study, the user may wish to target men between the ages of 21 and 35, for example. Questions regarding age and gender may be used in the screener questions to enable selection of the appropriate participants for the given study. Additionally, based upon the desired participant pool being used, the participants may be pre-screened by the system based upon known demographic data. For the vetted core panelists the amount of personal data known may be significant, thereby focusing in on eligible participants with little to no additional screener questions required. For the general panel population, however, less data is known, and often all but the most rudimentary qualifications may be performed automatically. After this qualification filtering of the participants, they may be subjected to the screener questions as discussed above.

In some embodiments it may be desirable to interrupt a study in progress in order to interject a new concept, offer or instruction. Particularly, in a mobile application there can be a software developer kit (SDK) that enables the integration into the study and interruption of the user in-process. The study interceptor manages this interruptive activity. Interruption of the user experience allows for immediate feedback testing or prompts to have the participant do some other activity.

Lastly, the study may include one or more events to occur in order to validate its successful completion. A task validator tracks these metrics for study completion. Generally, task validation falls into three categories: 1) completion of a particular action (such as arriving at a particular URL, URL containing a particular keyword, or the like), 2) completing a task within a time threshold (such as finding a product that meets criteria within a particular time limit), and 3) by question. Questions may include any definition of success the study designer deems relevant. This may include a simple “were you successful in the task?” style question, or a more complex satisfaction question with multiple gradient answers, for example.

The research module 350 enables timely and accurate insights into a user's experience. The research module includes basic functionalities, such as playback of any video or audio recordings by the playback module. This module, however, may also include a machine transcription of the audio, which is then time synchronized to the audio and/or video file. This allows a user to review and search the transcript (using keywords or the like) and immediately be taken to the relevant timing within the recording. The results may be annotated using an annotator as well. This allows, for example the user to select a portion of the written transcription and provide an annotation relevant to the study results. The system then automatically can use the timing data to generate an edited video/audio clip associated with the annotation. If the user later searches the study results for the annotation, this auto-generated clip may be displayed for viewing.

In addition to the video and/or audio recordings, the clickstream for the participant is recorded and mapped out as a branched tree, by a click stream analyzer. This may be aggregated with other participants' results for the study, to provide the user an indication of what any specific participant does to complete the assigned task, or some aggregated group generally does. The results aggregator likewise combines task validation findings into aggregate numbers for analysis.

All results may be searched and filtered by a filtering engine based upon any delineator. For example, a user may desire to know what the pain points of a given task are, and thus filters the results only by participants that failed to complete the task. Trends in the clickstream for these individuals may illustrate common activities that result in failure to complete the task. For example, if the task is to find a laptop computer with a dedicated graphics card for under a set price, and the majority of people who fail to successfully complete this task end up stuck in computer components due to typing in a search for “graphics card” this may indicate that the search algorithm requires reworking to provide a wider set of categories of products, for example.

As noted above, the filtering may be by any known dimension (not simply success or failure events of a task). For example, during screening or as part of a survey attending the study, income levels, gender, education, age, shopping preferences, etc. may all be discovered. It is also possible that the participant pool includes some of this information in metadata associated with the participant as well. Any of this information may be used to drill down into the results filtering. For example it may be desired to filter for only participants over a certain age. If after a certain age success rates are found to drop off significantly, for example, it may be that the font sizing is too small, resulting in increased difficulty for people with deteriorating eyesight.

Likewise, any of the results may be subject to annotations. Annotations allow for different user reviewers to collectively aggregate insights that they develop by reviewing the results, and allows for filtering and searching for common events in the results.

All of the results activities are additionally ripe for machine learning analysis using deep learning, which is where the data learning system 120 is able to excel. For example, the known demographic information may be fed into a recursive neural network (RNN) or convoluted neural network (CNN) to identify which features are predictive of a task being completed or not. Even more powerful is the ability for the clickstream to be fed as a feature set into the neural network to identify trends in click flow activity that are problematic or result in a decreased user experience.

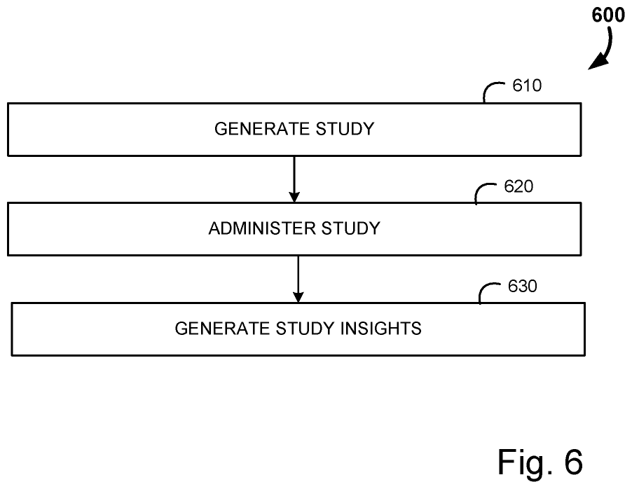

Turning now to FIG. 6, a flow diagram of the process of user experience study testing is provided generally at 600. At a high level this process includes three basic stages: the generation of the study (at 610) the administration of the study (at 620) and the generation of the study insights (at 630).

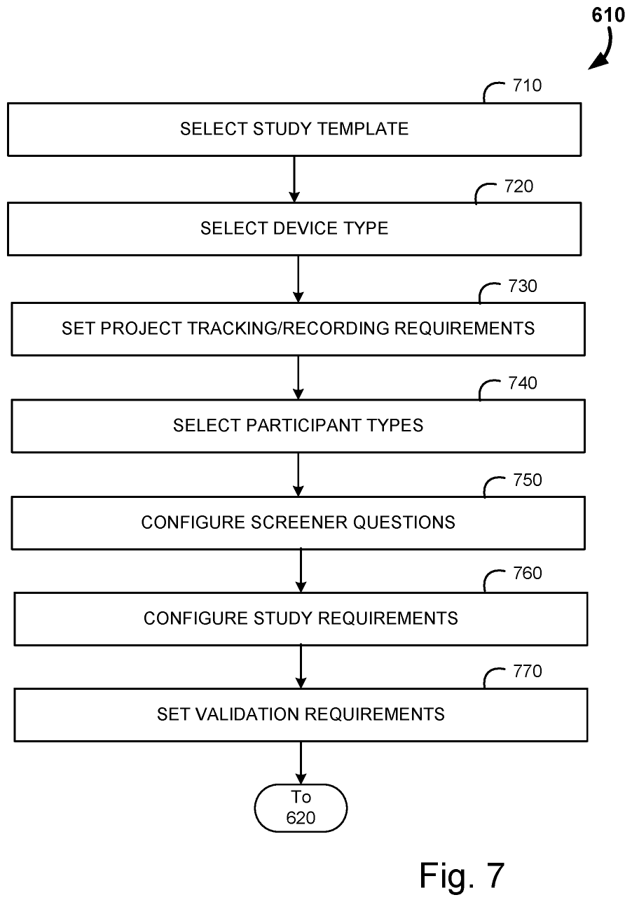

FIG. 7 provides a more detailed flow diagram of the study generation 610. As noted before, the present systems and methods allows for improved study generation by the usage of study templates which are selected (at 710) based upon the device the study is to be implemented on, and the type of study that is being performed. Study templates may come in alternate languages as well, in some embodiments. Study types generally include basic usability testing, surveys, card sort, tree test, click test, live intercept and advanced user insight research. The basic usability test includes audio and/or video recordings for a relatively small number of participants with feedback. A survey, on the other hand, leverages large participant numbers with branched survey questions. Surveys may also include randomization and double blind studies. Card sort, as discussed in great detail previously, includes open or closed card sorting studies. Tree tests assess the ease in which an item is found in a website menu by measuring where users expect to locate specific information. Click test measures first impressions and defines success areas on a static image as a heat map graph. Lastly, advanced research includes a combination of the other methodologies with logical conditions and task validation, and is the subject of much of the below discussions. Each of these study types includes separate saved template designs.

Device type is selected next (at 720). As noted before, mobile applications enable SDK integration for user experience interruption, when this study type is desired. Additionally, the device type is important for determining recording ability.

The study tracking and recording requirements are likewise set (at 730). Further, the participant types are selected (at 740). The selection of participants may include a selection by the user to use their own participants, or rely upon the study system for providing qualifies participants. If the study system is providing the participants, a set of screener questions are generated (at 750). These screener questions may be saved for later usage as a screener profile. The core participants and larger general panel participants may be screened until the study quota is filled.

Next the study requirements are set (at 760). Study requirements may differ based upon the study type that was previously selected. For example, the study questions are set for a survey style study, or advanced research study. In basic usability studies and research studies the task may likewise be defined for the participants. For tree tests the information being sought is defined and the menu uploaded. For click test the static image is selected for usage. Lastly, the success validation is set (at 770) for the advanced research study.

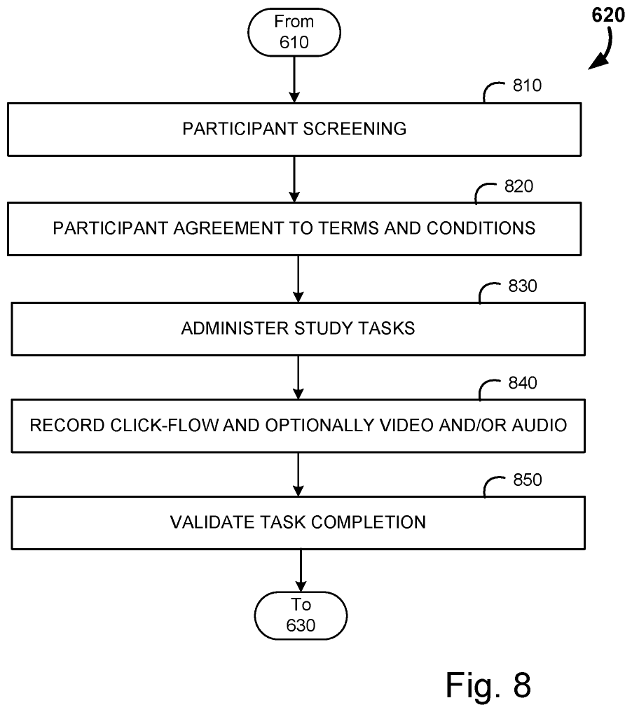

After study generation, the study may be implemented, as shown in greater detail at 620 of FIG. 8. Study implementation begins with screening of the participants (at 810). This includes initially filtering all possible participants by known demographic or personal information to determine potentially eligible individuals. For example, basic demographic data such as age range, household income and gender may be known for all participants. Additional demographic data such as education level, political affiliation, geography, race, languages spoken, social network connections, etc. may be compiled over time and incorporated into embodiments, when desired. The screener profile may provide basic threshold requirements for these known demographics, allowing the system to immediately remove ineligible participants from the study. The remaining participants may be provided access to the study, or preferentially invited to the study, based upon participant workload, past performance, and study quota numbers. For example, a limited number (less than 30 participants) video recorded study that takes a long time (greater than 20 minutes) may be provided out on an invitation basis to only core panel participants with proven histories of engaging in these kinds of studies. In contrast, a large survey requiring a thousand participants that is expected to only take a few minutes may be offered to all eligible participants.

The initially eligible participants are then presented with the screener questions. This two-phased approach to participant screening ensures that participants are not presented with studies they would never be eligible for based upon their basic demographic data (reducing participant fatigue and frustration), but still enables the user to configure the studies to target a particular participant based upon very specific criteria (e.g., purchasing baby products in the past week for example).

After participants have been screened and are determined to still meet the study requirements, they are asked to accept the study terms and conditions (at 820). As noted before, privacy regulations play an ever increasing role in online activity, particularly if the individual is being video recorded. Consent to such recordings is necessitated by these regulations, as well as being generally a best practice.

After conditions of the study are accepted, the participant may be presented with the study task (at 830) which, again, depends directly upon the study type. This may include navigating a menu, finding a specific item, locating a URL, answering survey questions, providing an audio feedback, card sorting, clicking on a static image, or some combination thereof. Depending upon the tasks involved, the clickstream and optionally audio and/or video information may be recorded (at 840). The task completion is likewise validated (at 850) if the success criteria is met for the study. This may include task completion in a particular time, locating a specific URL, answering a question, or a combination thereof.

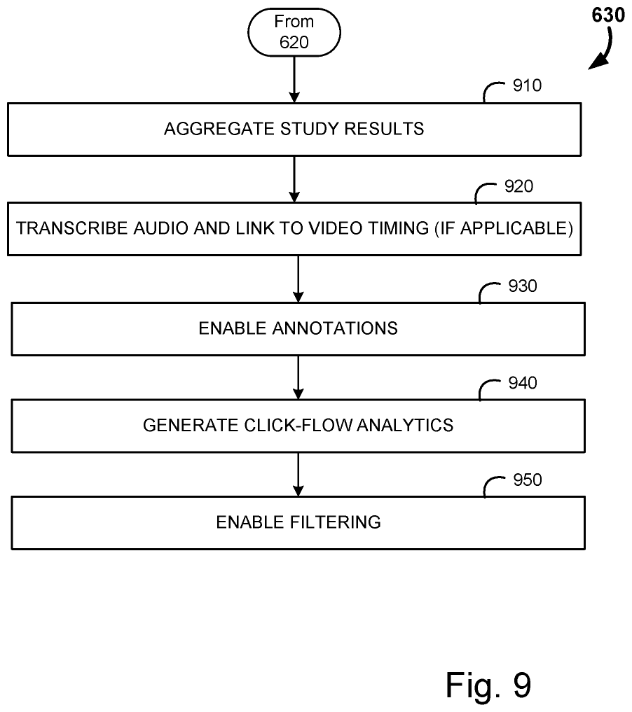

After study administration across the participant quota, insights are generated for the study based upon the results, as seen at 630 of FIG. 9. Initially the study results are aggregated (at 910). This includes graphing the number of studies that were successful, unsuccessful and those that were abandoned prior to completion. Confidence intervals may be calculated for these graphs. Similarly, survey question results may be aggregated and graphed. Clickstream data may be aggregated and the likelihood of any particular path may be presented in a branched graphical structure. Aggregation may include the totality of all results, and may be delineated by any dimension of the study.

When an audio or video recording has been collected for the study, these recordings may be transcribed using machine voice to text technology (at 920). Transcription enables searching of the audio recordings by keywords. The transcriptions may be synchronized to the timing of the recording, thus when a portion of the transcription is searched, the recording will be set to the corresponding frames. This allows for easy review of the recording, and allows for automatic clip generation by selecting portions of the transcription to highlight and tag/annotate (at 930). The corresponding video or audio clip is automatically edited that corresponds to this tag for easy retrieval. The clip can likewise be shared by a public URL for wider dissemination. Any portion of the results, such as survey results and clickstream graphs, may similarly be annotated for simplified review.

As noted, clickstream data is analyzed (at 940). This may include the rendering of the clickstream graphical interface showing what various participants did at each stage of their task. As noted before, deep learning neural networks may consume these graphs to identify ‘points of confusion’ which are transition points that are predictive of a failed outcome.

All the results are filterable (at 950) allowing for complex analysis across any study dimension. Here too, machine learning analysis may be employed, with every dimension of the study being a feature, to identify what elements (or combination thereof) are predictive of a particular outcome. This information may be employed to improve the design of subsequent website designs, menus, search results, and the like.

Although not illustrated, video recording also enables additional analysis not previously available, such as eye movement tracking and image analysis techniques. For example, a number of facial recognition tools are available for emotion detection. Key emotions such as anger, frustration, excitement and contentment may be particularly helpful in determining the user's experience. A user who exhibits frustration with a task, yet still completes the study task may warrant review despite the successful completion. Results of these advanced machine learning techniques may be automatically annotated into the recording for search by a user during analysis.

While the above discussion has been focused upon testing the user experience in a website for data generation, it is also possible that these systems and methods are proactively deployed defensively against competitors who are themselves engaging in user experience analysis. This includes first identifying when a user experience test is being performed, and taking some reaction accordingly. Red-flag behaviors, such as redirection to the client's webpage from a competitive user experience analytics firm is one clear behavior. Others could include a pattern of unusual activity, such as a sudden increase in a very discrete activity for a short duration.

Once it is determined that a client's website has been targeted for some sort of user experience test, the event is logged. At a minimum this sort of information if helpful to the client in planning their own user experience tests, and understanding what their competitors are doing. However, in more extreme situations, alternate web portals may be employed to obfuscate the analysis being performed.

C. Customer Data Learning Systems and Methods

As discussed previously, the customer data learning system 120 proposes a solution to the challenge of having data that is physical or logically separated due to contractual and/or legal requirements, yet would be beneficial for combining to train or otherwise improve algorithms. Specifically, the customer data learning system 120 is the end-to-end environment that allows the operator to learn from multiple separate data sets without the need to combine the data logically or physically. The customer data learning system 120 includes capabilities for the creation and management of separate data sets, algorithm-based learning on these data sets either individually or as an aggregate, and application of algorithms and other computing methods on these separate data sets, while maintaining the privacy and security of each data set and ensuring compliance with all contractual data use obligations, as defined by a policy module 140.

There are a variety of training patterns that allow secure computing on multiple, separate data sets. In some cases, entire locally trained models are transmitted back to a central system for aggregation. In this case, for example, individually trained models may be combined into an ensemble model. Outputs from ensemble models can be likened to a voting process: Each model “votes” by providing its answer. If outputs are numerical, then one way of deciding the output of the overall algorithm is to create a weighted average of the votes, or to select a median value or even a range of outputs. For non-numerical data, an ensemble of models can output the category that has the most votes or the vote from the model that is most “confident” in its output. In other cases, model parameters are transmitted back and combined mathematically to create an aggregate model. In this situation, all models are the same functional form, so model parameters can be averaged, or a median parameter value could be used. For example, imagine a linear regression model that is trained on three separate data sets. Such a model, in general, will have a single offset and then a slope for each input. The linear regression learned over the combined data could be constructed from the weighted average of the offsets of the individually trained models and the weighted averages of the individually trained slopes. A variation of this method operates on small sub-batches of the data in each local repository to compute incremental changes to the model parameters. The master model and each local model is updated by these incremental changes and each data set contributes changes in turn, repeatedly, until the model parameters have converged to stable values. In still other methods, a student-teacher paradigm is employed in which a locally trained algorithm makes inferences on a shared data set, and the outputs of that process are transmitted to the central system. In this methodology, all of the inputs from a data set that can be shared among all the different participants (e.g. a publicly available data set) are supplied to the locally trained models. The master model is trained independently on all of the copies of the shared data that were labeled by the local models. For 10 local models and 1000 shared inputs, there would be 10*1000=10,000 total labeled training examples to train the master model.

The customer data learning system 120 is designed to configure software, data and computing systems in such a way as to support one or more of these computing paradigms so that the user experience company can provide the best possible algorithmic value to its customers, while maintaining the highest standards of privacy and security.

Turning to FIG. 4, a more detailed block diagram of the integration module 130 of the customer data learning system 120 is provided. As previously noted, the integration module 130 is the workhorse behind the customer data learning system 120, responsible for developing functionalities and deploying them all within the constraints dictated by the policy module 140.

The integration module 130 includes a development module 132 which generates the software to be deployed in the local customer data modules 150a-n. Software to be applied to the local data includes at least four categories of functionality: 1) computation on local data to generate new insights for customers, 2) annotation of local data to allow new algorithm development or refinement of existing algorithms, 3) training of algorithms on local data, and 4) interactive operation of software workflows to allow collaboration between the user experience company and customer or local operator. Software developed in this development module 132 is aware of security, privacy and other requirements based upon input from the policy module 140, with may control which computations may be run on which data, and how the results may be transmitted or used. Software developed in the development module 132 may also include support for advanced security methods such as homomorphic encryption and tracking of data packets to ensure that appropriate levels of privacy and security are maintained.

The deployment module 134 manages the deployment of software developed in development module 132 to allow it to compute on data in the local customer data module 150a-n in an efficient and secure way. In some embodiments, the deployment module 134 operates within a single computing environment managed by the user experience company to perform specific computations on specific individual separate data sets without combining the data logically or physically.

In other embodiments, the deployment module 134 packages software into discrete bins that are designed to be run in a customer's local computing environment within each local customer data module 150a-n. This discrete bin approach provides for the specification of all of the computing environment requirements that are needed at the local computing site, and optionally allows for orchestration of the computing in a variety of computing architectures (e.g. single-node computing, high-performance computing cluster, distributed data parallel computing cluster, etc.). This deployment module 134 also ensures that any interactive collaboration tools are properly deployed to an interactive collaboration system 138 and local customer data module 150a-n so that collaborative activities can be performed.

The interactive collaboration system 138 supports interactive collaboration between the user experience company's personnel, and customers or local operators at local customer data module 150a-n. Interactive collaboration allows a number of highly valuable activities, such as operation of production of user experience testing functionality, annotation of data for algorithm training purposes, debugging or troubleshooting of local computing processes and organization, cataloguing and cleaning of local data to improve system performance.

One example of an interactive collaborative tool would be data annotation, in which an operator local to the data might manually label a data set to train a new algorithm. For example, if it is desired to identify moments in a video in which a user of a website is confused, then clear consistent criteria for what constitutes confusion and when the confusion takes place is needed in order to train a master algorithm on multiple data sets. Also, the actual mechanics of recording an annotation along with the data must be managed in a way that allows the data to be used by UserZoom for algorithm training. UserZoom would deploy an annotation tool to each local data site and potentially interactively work with each local operator to teach them the preferred annotation criteria, to review the results of some annotations with the local operator and to remotely monitor the process to ensure that a sufficient amount of data is being annotated. Another example of interactive collaboration would be to identify new data or prepare it for algorithm training. For example, if the local operator has recorded notes from UserZoom sessions, these notes may need to be copied to a new location and perhaps reformatted for use by UserZoom for algorithm training. It is frequently necessary for the UserZoom data scientist to assist the local operator in identifying the required data and transferring it into the proper data format and storage structure. In some cases, such an interactive tool might even be the opening of a remote screen sharing or video session, which would allow both parties to collaborate to address a specific data issue or need.

The training aggregation module 136 receives software components from deployment module 132 and data from multiple instances of local customer data modules 150a-n to aggregate results into a single algorithm that has learned from all of the separate data sets. Depending upon the privacy restrictions and learning algorithm used (per the policy module 140), data from local customer data module 150a-n can include trained models, trained model parameters, privacy-preserving synthetic data created from local data or specific computational results. Depending upon the method being used, this information is aggregated to create an algorithm that encodes learning from potentially all of the separate data sets, thus allowing the user experience company to create robust analytical tools and algorithms based on a broad variety of data sources and customer situations. This is a critical capability of the customer data learning system 120, because it allows the user experience company to learn from many different customer data sets without sharing private data or breaking its contractual obligations, and consequently allows the user experience company to provide vastly superior algorithmic capabilities to all of its customers.

For example, individually trained models may be combined into an ensemble model. Outputs from ensemble models can be likened to a voting process: Each model “votes” by providing its answer. If outputs are numerical, then one way of deciding the output of the overall algorithm is to create a weighted average of the votes, or to select a median value or even a range of outputs. For non-numerical data, an ensemble of models can output the category that has the most votes or the vote from the model that is most “confident” in its output. In other cases, model parameters are transmitted back and combined mathematically to create an aggregate model. In this situation, all models are the same functional form, so model parameters can be averaged, or a median parameter value could be used. For example, imagine a linear regression model that is trained on three separate data sets. Such a model, in general, will have a single offset for the whole model and a slope parameter for each input variable. The linear regression learned over the combined data could be constructed from the weighted average of the offsets of the individually trained models and the weighted averages of the individually trained slopes. A variation of this method operates on small sub-batches of the data in each local repository to compute incremental changes to the model parameters. The master model and each local model are updated by these incremental changes and each data set contributes changes in turn, repeatedly, until the model parameters have converged to stable values. In still other methods, a student-teacher paradigm is employed in which a locally trained algorithm makes inferences on a shared data set, and the outputs of that process are transmitted to the central system. In this methodology, all of the inputs from a data set that can be shared among all the different participants (e.g. a publicly available data set) are supplied to the locally trained models. The master model is trained independently on all of the copies of the shared data that were labeled by the local models. For 10 local models and 1000 shared inputs, there would be 10*1000=10,000 total labeled training examples to train the master model.

Moving on to FIG. 5, a more detailed example of a local customer data module 150a is provided. In this local customer data module 150a, a local compute device 152 runs software deployed by the deployment module 132 securely for a variety of purposes. These applications include, but are not limited to, computing upon local customer data 156 to generate new insights about that data, training of an algorithm on this local customer data 156, annotation of the local customer data 156 to supplement or augment it, create training labels for future algorithm training, and interactive collaboration between the user experience company and the customer (or local operator) to augment the local customer data 156.

The application/software run on the local compute device 152 may also be used to perform user experience studies, clean data, annotate data, manage data, catalogue data or otherwise create value. Results from computations, including, in some embodiments, performance metrics, inferences, new trained models, parameters or results from new trained models, metadata about data and many other results are transmitted back to the integration module 130 in both asynchronous modes and interactive collaboration modes via the interactive collaboration system 138.

A data management module 154 manages the contents of the local customer data 156. Activities in the data management module 154 include, for example, reporting on existing data, updating data with annotations or other augmentations (both asynchronous and through the interactive collaboration system 138), enforcing security and privacy access controls, and implementation of data cleaning and quality monitoring processes. Security and privacy access controls may include ensuring that local customer data 156 is only accessed for permitted purposes and/or that data is not inadvertently exported from system or otherwise shared or merged with other data inappropriately, per the policy module 140. The data management module 154 may publish metadata about the contents of local customer data 156 to the integration module 130.

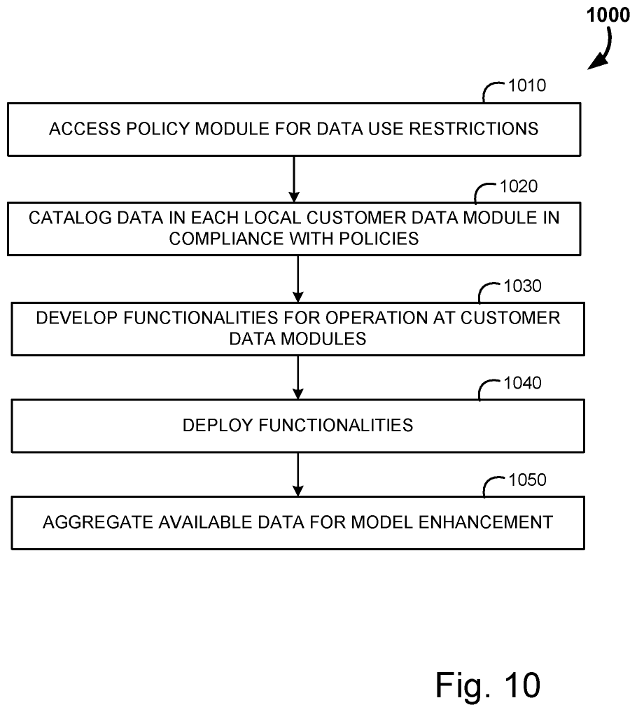

Attention will now be turned to FIG. 10 which provides an example process at 1000 for algorithm training using un-combinable datasets. The process begins with the accessing of the policy module (at 1010) for limitations on what data is to be comingled, shared or accessed. In some embodiments, this policy module is populated with legal limitations on sharing of data, as well as configured rules based upon contractual obligations. In some embodiments the policy module is accessible by a user interface and includes a Boolean rule based interface. The user can select applicable regulations (e.g., HIPPA, GDPR, etc.) that apply to a selected database, as well as imputing the contractual restrictions. This includes which entities the raw data may be shared with, degree of abstractions allowed, temporal restrictions upon secrecy, and the like.

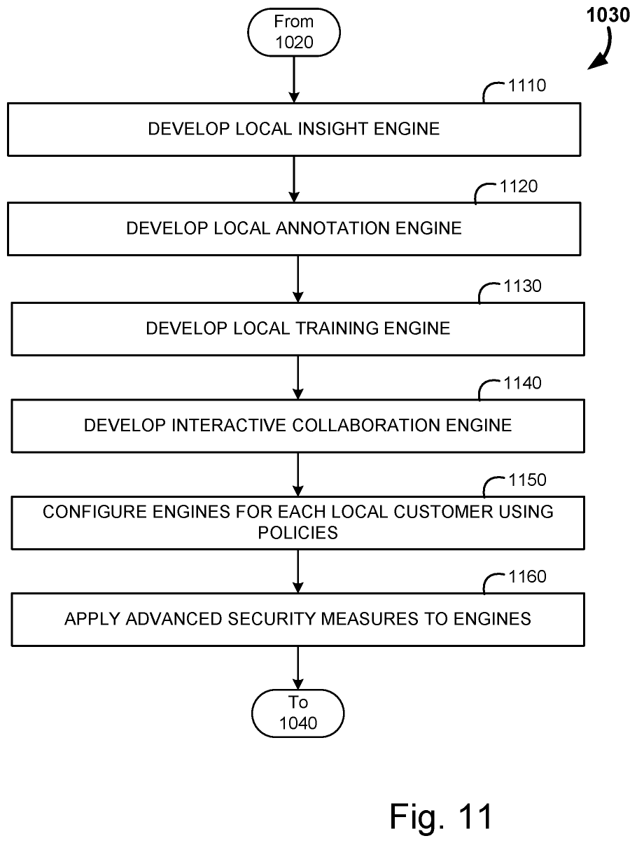

After querying the policy module, the process catalogs data in each of the local consumer data modules (at 1020) in a manner that comports to the policy requirements. After the catalog of data is compiled, various functionalities (software modules extracting or transforming data to generate valuable abstractions) is developed (at 1030). FIG. 11 provides a more detailed flow diagram of this functionality development process. One of the functionalities developed includes local insight engines (at 1110), local annotation engines (at 1120), local training engines (at 1130), and interactive collaborate engines (at 1140). A local insight engine would be an algorithm that was trained elsewhere (e.g. a master algorithm created by UserZoom on data from previous customers) and subsequently applied to a new customer's data. Insights can be any computed quantity, but in AI applications they are inferences from unstructured data, such as interpretations of facial expressions in video, predictions of where in a workflow a user became confused or a model to aggregate different views of the same web page to create simpler maps of user workflow experience. A local annotation engine is used by a local operator, who is familiar with the meaning of the local data but is not usually a data scientist, to create labeled data for algorithm training purposes. An example of a labeling process would be to identify moments in videos when users become confused or frustrated. Other annotations might be to identify when a user left the preferred user workflow, or to identify in audio data when a user has “given up” on a task. Local training refers to the training of an algorithm on local data. In some cases, a locally trained algorithm is the ultimate objective, for example when a customer has a unique data challenge that needs to be solved via machine learning/AI or when the local data has attributes that make it substantially different from other data sets. In other cases, local training is part of the training of a master algorithm that has learned from multiple local data sets. Finally, interactive, collaborative tools are software tools that have been deployed locally by UserZoom for use by local operators, who may need interactive instruction, or who may need to perform data cleaning, formatting or storage activities under the guidance of UserZoom personnel. Data annotation may be performed as an interactive, collaborative process, or as an asynchronous activity done locally.

Subsequently, each of the developed engines are configured (at 1150) for each of the local customer data modules based upon the data restriction policies. Advanced security measures, such as homomorphic encryption and data packet tracking, are then applied (at 1160).

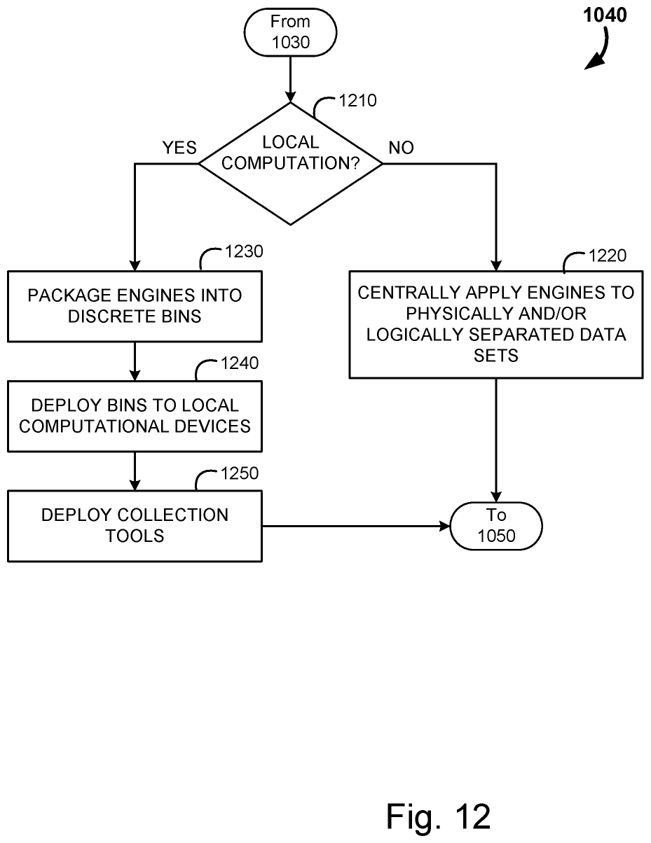

Returning to FIG. 10, after functionality development, they may be deployed (at 1040) to the various local customer data modules. FIG. 12 provides a more detailed flow diagram of this functionality deployment process. Initially a determination is made (at 1210) whether the functionality will be locally executed at the local data module, or centrally executed by the integration module. If central processing is desired, the method progresses to where the developed engines are applied to the physically and/or logically separate data sets in the user experience systems directly (at 1220).

Alternatively, if local computation is desired, then the engines are packaged (at 1230) into discrete bins in accordance with policy requirements. These bins are deployed (at 1240) to the local computational devices for local execution. Additionally collection tools are deployed (at 1250) to the local computational devices for compilation of the outputs from the engines to return to the aggregation module for downstream usage.

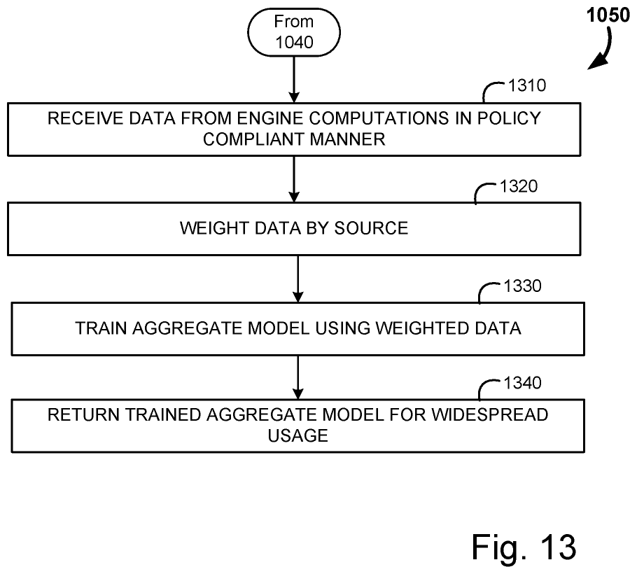

Returning to FIG. 10, after functionality deployment the available data is aggregated for model enhancements (at 1050). FIG. 13 provides a more detailed flow diagram for this aggregation and algorithm improvement process. Initially, data is received from the engine(s) computations (at 1310) in a manner that comports to all applicable policies. This includes cross referencing the policies to the data source to either exclude data below a certain level of abstraction. These policies may be data type dependent (e.g., personally identifiable information, specific financial or technical information, source identifiable, etc.), time based (e.g., data within a certain timeframe), or degree of granularity (e.g., store level data, customer level data, site level data, etc.).

The collected data is then weighted by the data source (at 1320). This weighting, at a very basic level, may be based upon the sample size. For example, if one customer data module includes twice the data records as another consumer data source, the model variables, annotation aggregates, or extrapolated synthetic training data, may be either twice the quantity (when applicable), or afforded double the weight (such as when model variables are returned). In addition to database size, other factors may be considered in this weighting process, including assessing the general subjective quality of the datasets (based upon human review, for example), resources dedicated by the customer in generation of the datasets, prior dataset predictive ability, dataset longevity, dataset diversity, etc. The method can also use the prediction confidence value of each model prediction, or the performance of the model on a shared data set.

After weighting, the aggregation module can train an aggregate model using the data received from the various functionality engines weighted accordingly (at 1330). The trained aggregate model is returned for widespread usage (at 1340). This allows for all available data to be leveraged in the generation of more efficient, accurate and robust algorithms, without compromising any data use restrictions.

D. System Embodiments

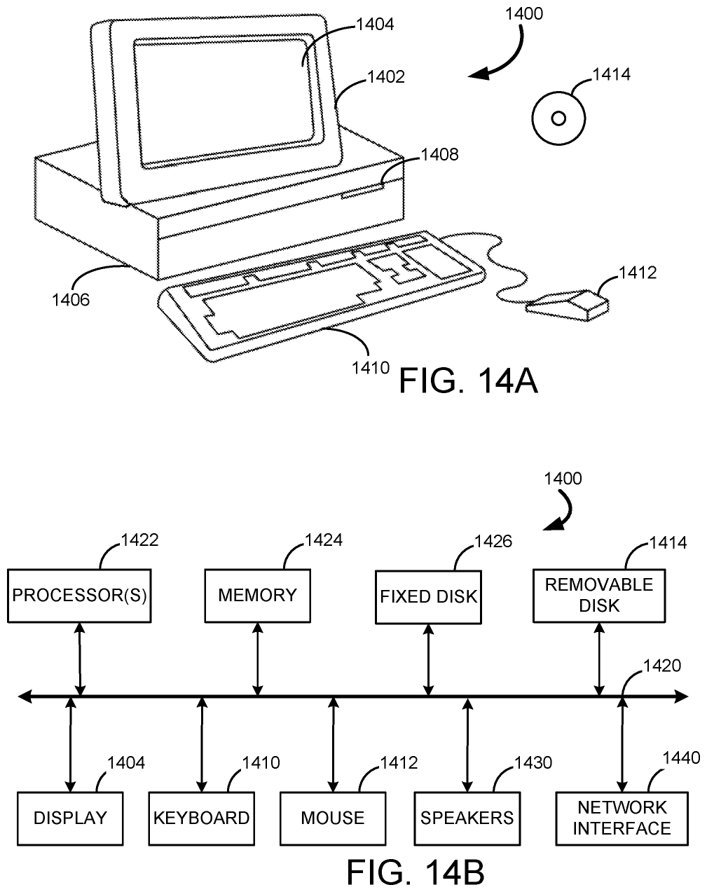

Now that the systems and methods for the improvement in algorithm generation and training using restricted datasets have been described, attention shall now be focused upon systems capable of executing the above functions. To facilitate this discussion, FIGS. 14A and 14B illustrate a Computer System 1400, which is suitable for implementing embodiments of the present invention. FIG. 14A shows one possible physical form of the Computer System 1400. Of course, the Computer System 1400 may have many physical forms ranging from a printed circuit board, an integrated circuit, and a small handheld device up to a huge super computer. Computer system 1400 may include a Monitor 1402, a Display 1404, a Housing 1406, a Storage Drive 1408, a Keyboard 1410, and a Mouse 1412. Storage 1414 is a computer-readable medium used to transfer data to and from Computer System 1400.

FIG. 14B is an example of a block diagram for Computer System 1400. Attached to System Bus 1420 are a wide variety of subsystems. Processor(s) 1422 (also referred to as central processing units, or CPUs) are coupled to storage devices, including Memory 1424. Memory 1424 includes random access memory (RAM) and read-only memory (ROM). As is well known in the art, ROM acts to transfer data and instructions uni-directionally to the CPU and RAM is used typically to transfer data and instructions in a bi-directional manner. Both of these types of memories may include any suitable of the computer-readable media described below. A Fixed Storage 1426 may also be coupled bi-directionally to the Processor 1424; it provides additional data storage capacity and may also include any of the computer-readable media described below. Fixed Storage 1426 may be used to store programs, data, and the like and is typically a secondary storage medium (such as a hard disk) that is slower than primary storage. It will be appreciated that the information retained within Fixed Storage 1426 may, in appropriate cases, be incorporated in standard fashion as virtual memory in Memory 1424. Removable Storage 1414 may take the form of any of the computer-readable media described below.

Processor 1424 is also coupled to a variety of input/output devices, such as Display 1404, Keyboard 1410, Mouse 1412 and Speakers 1430. In general, an input/output device may be any of: video displays, track balls, mice, keyboards, microphones, touch-sensitive displays, transducer card readers, magnetic or paper tape readers, tablets, styluses, voice or handwriting recognizers, biometrics readers, motion sensors, brain wave readers, or other computers. Processor 1422 optionally may be coupled to another computer or telecommunications network using Network Interface 1440. With such a Network Interface 1440, it is contemplated that the Processor 1422 might receive information from the network or might output information to the network in the course of performing the above-described algorithm training. Furthermore, method embodiments of the present invention may execute solely upon Processor 1422 or may execute over a network such as the Internet in conjunction with a remote CPU that shares a portion of the processing.

Software is typically stored in the non-volatile memory and/or the drive unit. Indeed, for large programs, it may not even be possible to store the entire program in the memory. Nevertheless, it should be understood that for software to run, if necessary, it is moved to a computer readable location appropriate for processing, and for illustrative purposes, that location is referred to as the memory in this disclosure. Even when software is moved to the memory for execution, the processor will typically make use of hardware registers to store values associated with the software, and local cache that, ideally, serves to speed up execution. As used herein, a software program is assumed to be stored at any known or convenient location (from non-volatile storage to hardware registers) when the software program is referred to as “implemented in a computer-readable medium.” A processor is considered to be “configured to execute a program” when at least one value associated with the program is stored in a register readable by the processor.

In operation, the computer system 1400 can be controlled by operating system software that includes a file management system, such as a storage operating system. One example of operating system software with associated file management system software is the family of operating systems known as Windows® from Microsoft Corporation of Redmond, Wash., and their associated file management systems. Another example of operating system software with its associated file management system software is the Linux operating system and its associated file management system. The file management system is typically stored in the non-volatile memory and/or drive unit and causes the processor to execute the various acts required by the operating system to input and output data and to store data in the memory, including storing files on the non-volatile memory and/or drive unit.

Some portions of the detailed description may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is, here and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

The algorithms and displays presented herein are not inherently related to any particular computer or other apparatus. Various general-purpose systems may be used with programs in accordance with the teachings herein, or it may prove convenient to construct more specialized apparatus to perform the methods of some embodiments. The required structure for a variety of these systems will appear from the description below. In addition, the techniques are not described with reference to any particular programming language, and various embodiments may, thus, be implemented using a variety of programming languages.

In alternative embodiments, the machine operates as a standalone device or may be connected (e.g., networked) to other machines. In a networked deployment, the machine may operate in the capacity of a server or a client machine in a client-server network environment or as a peer machine in a peer-to-peer (or distributed) network environment.

The machine may be a server computer, a client computer, a virtual machine, a personal computer (PC), a tablet PC, a laptop computer, a set-top box (STB), a personal digital assistant (PDA), a cellular telephone, an iPhone, a Blackberry, a processor, a telephone, a web appliance, a network router, switch or bridge, or any machine capable of executing a set of instructions (sequential or otherwise) that specify actions to be taken by that machine.

While the machine-readable medium or machine-readable storage medium is shown in an exemplary embodiment to be a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding or carrying a set of instructions for execution by the machine and that cause the machine to perform any one or more of the methodologies of the presently disclosed technique and innovation.

In general, the routines executed to implement the embodiments of the disclosure may be implemented as part of an operating system or a specific application, component, program, object, module or sequence of instructions referred to as “computer programs.” The computer programs typically comprise one or more instructions set at various times in various memory and storage devices in a computer, and when read and executed by one or more processing units or processors in a computer, cause the computer to perform operations to execute elements involving the various aspects of the disclosure.

Moreover, while embodiments have been described in the context of fully functioning computers and computer systems, those skilled in the art will appreciate that the various embodiments are capable of being distributed as a program product in a variety of forms, and that the disclosure applies equally regardless of the particular type of machine or computer-readable media used to actually effect the distribution

While this invention has been described in terms of several embodiments, there are alterations, modifications, permutations, and substitute equivalents, which fall within the scope of this invention. Although sub-section titles have been provided to aid in the description of the invention, these titles are merely illustrative and are not intended to limit the scope of the present invention. It should also be noted that there are many alternative ways of implementing the methods and apparatuses of the present invention. It is therefore intended that the following appended claims be interpreted as including all such alterations, modifications, permutations, and substitute equivalents as fall within the true spirit and scope of the present invention.

What is claimed is:

1. A method for improving an algorithm for a user experience testing provider using physically or logically partitioned datasets in compliance with use restrictions, the method comprising:
querying a policy database for a user experience testing provider for use restrictions on a plurality of partitioned datasets belonging to a plurality of customers stored in a plurality of local data modules;
cataloging the plurality of datasets;
generating a set of functionality applications for improving user experience testing models, responsive to the restrictions;
deploying the functionality applications to the plurality of partitioned datasets to generate outputs that are compliant with the restrictions;
aggregating the outputs; and
training at least one user experience testing model using the outputs.

2. The method of claim 1, wherein the restrictions are at least one of contractually and legally mandated.

3. The method of claim 2, wherein the restrictions include prohibitions of sharing data from one dataset to another due to non-disclosure contractual clauses.

4. The method of claim 2, wherein the restrictions include privacy regulations.

5. The method of claim 4, wherein the privacy regulations include at least one of the GDPR and HIPPA.

6. The method of claim 1, wherein the functionality applications include computation on the plurality of datasets to generate new insights for customers, annotation of the plurality of datasets to allow new algorithm development or refinement of existing algorithms, training of algorithms on the plurality of datasets, and interactive operation of software workflows to allow collaboration between a user experience company and a customer or local operator.

7. The method of claim 1, wherein the deploying the functionality includes running the functionality on a central system on partitions of the plurality of datasets adhering to the restrictions.

8. The method of claim 1, wherein the deploying the functionality includes packaging the functionality into discrete bins for each of the plurality of datasets, and delivering the bins to local computational devices at each local data module.

9. The method of claim 8, wherein the packaging the functionality is performed in accordance to the restrictions.

10. The method of claim 1, wherein the aggregating is a weighted function.

11. The method of claim 10, wherein the weighted function weights are based upon at least one of confidence value for the output, sample size of the dataset, diversity of the dataset, longevity of the dataset, and historic predictive accuracy of the dataset.

12. A system for improving an algorithm for a user experience testing provider using physically or logically partitioned datasets in compliance with use restrictions, the system comprising:
a policy database for a user experience testing provider for querying use restrictions on a plurality of partitioned datasets belonging to a plurality of customers stored in a plurality of local data modules;
a central data processing unit for cataloging the plurality of datasets;
a functionality development engine for generating a set of functionality applications for improving user experience testing models responsive to the restrictions;
a functionality deployer for deploying the functionality applications to the plurality of partitioned datasets to generate outputs that are compliant with the restrictions;
an aggregator for aggregating the outputs; and
the central data processing unit further for training at least one user experience testing model using the outputs.

13. The system of claim 12, wherein the restrictions are contractually and legally mandated.

14. The system of claim 13, wherein the restrictions include prohibitions of sharing data from one dataset to another due to non-disclosure contractual clauses.

15. The system of claim 13, wherein the restrictions include privacy regulations.

16. The system of claim 15, wherein the privacy regulations include at least one of the GDPR and HIPPA.

17. The system of claim 12, wherein the functionality applications include computation on the plurality of datasets to generate new insights for customers, annotation of the plurality of datasets to allow new algorithm development or refinement of existing algorithms, training of algorithms on the plurality of datasets, and interactive operation of software workflows to allow collaboration between a user experience company and a customer or local operator.

18. The system of claim 12, wherein the deploying the functionality includes finning the functionality on a central system on partitions of the plurality of datasets adhering to the restrictions.

19. The system of claim 12, wherein the deploying the functionality includes packaging the functionality into discrete bins for each of the plurality of datasets, and delivering the bins to local computational devices at each local data module.

20. The system of claim 19, wherein the packaging the functionality is performed in accordance to the restrictions.

21. The system of claim 12, wherein the aggregating is a weighted function.

22. The system of claim 21, wherein the weighted function weights are based upon at least one of confidence value for the output, sample size of the dataset, diversity of the dataset, longevity of the dataset, and historic predictive accuracy of the dataset.
